(19) United States
(12) Patent Application Publication
(10) Pub. No.: US 2016/0154580 A1
(43) Pub. Date: Jun. 2, 2016

(54) ELECTRONIC APPARATUS AND METHOD

(71) Applicant: Kabushiki Kaisha Toshiba, Tokyo (JP)

(72) Inventor: Hirotada Hirabayashi, Hamura Tokyo (JP)

(21) Appl. No.: 15/013,564

(22) Filed: Feb. 2, 2016

Related U.S. Application Data
(63) Continuation of application No. PCT/JP2014/056531, filed on Mar. 12, 2014.

(51) Int. Cl. G06F 3/0488; G06F 3/0482; G06K 9/00; G06F 17/22; G06F 17/21; G06F 17/27; G06F 3/0484; G06F 17/24

(52) U.S. Cl. CPC G06F 3/04883; G06F 3/04842; G06F 3/0482; G06F 17/242; G06F 17/2205; G06F 17/212; G06F 17/276; G06K 9/00416; G06K 9/00436

(57) ABSTRACT

According to one embodiment, a method includes displaying a document; receiving first strokes representing a first character made on document, wherein a stroke count of the first strokes is a first number; determining a first handwriting candidate comprising second strokes representing the first character whose stroke count is the first number; determining a second handwriting candidate comprising fourth strokes representing the first character whose stroke count is a second number; displaying the first and second handwriting candidates on; entering the first handwriting candidate into the document, if the first handwriting candidate is selected; and entering the second handwriting candidate into the document, if the second handwriting candidate is selected.

### CROSS-REFERENCE TO RELATED APPLICATIONS

This application is a Continuation Application of PCT Application No. PCT/JP2014/056531, filed Mar. 12, 2014, the entire contents of which are incorporated herein by reference.

### FIELD

Embodiments described herein relate generally to a technique of inputting a character string in handwriting.

### BACKGROUND

In recent years, various electronic apparatuses capable of inputting documents in handwriting, such as tablet computers, notebook personal computers, smartphones and PDAs, have been developed.

Accordingly, a technique is desirable to enable a handwritten document to be easily prepared.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view showing an example of an appearance of an electronic apparatus according to an embodiment.

FIG. 2 is a block diagram showing an example of cooperation between the electronic apparatus and other apparatuses.

FIG. 3 is a diagram showing an example of a handwritten document handwritten on a touchscreen display.

FIG. 4 is a diagram showing an example of a time-series data item which is a set of stroke data items.

FIG. 5 is a block diagram showing an example of a system configuration of the electronic apparatus.

FIG. 6 is a diagram showing an example of a home screen displayed by the electronic apparatus.

FIG. 7 is a diagram showing an example of a note preview screen displayed by the electronic apparatus.

FIG. 8 is a diagram showing an example of a setting screen displayed by the electronic apparatus.

FIG. 9 is a diagram showing an example of a page edit screen displayed by the electronic apparatus.

FIG. 10 is a diagram showing an example of a search dialog displayed by the electronic apparatus.

FIG. 11 is a block diagram showing an example of a functional configuration of a handwritten note application program executed by the electronic apparatus.

FIG. 12 is a diagram showing an example of a data structure of a suggest feature table.

FIG. 13 is a diagram showing an example of a data structure of a suggest keyword table.

FIG. 14 is a flowchart showing an example of a feature registration process.

FIG. 15 is a diagram for specifically explaining an integrated character recognition process.

FIG. 16 is a flowchart showing an example of a candidate display process.

FIG. 17 is a diagram for specifically explaining priority of each keyword.

FIG. 18 is a diagram showing an example of a candidate display area where a candidate for handwriting input is displayed.

FIG. 19 is a diagram showing an example of a handwriting input area where a candidate for handwriting input selected by a user is displayed.

### DETAILED DESCRIPTION

Various embodiments will be described hereinafter with reference to the accompanying drawings.

In general, according to one embodiment, a method includes displaying a document stored in a memory on a screen; receiving first strokes representing a first character made on document displayed on the screen, wherein a stroke count of the first strokes is a first number; determining a first handwriting candidate comprising second strokes representing the first character and a third stroke representing a second character, wherein a stroke count of the second strokes is the first number; determining a second handwriting candidate comprising fourth strokes representing the first character and a fifth stroke representing a third character, wherein a stroke count of the fourth strokes is a second number different from the first number; displaying the first handwriting candidate and the second handwriting candidate on the screen; entering the first handwriting candidate into the document, if the first handwriting candidate is selected; and entering the second handwriting candidate into the document, if the second handwriting candidate is selected.

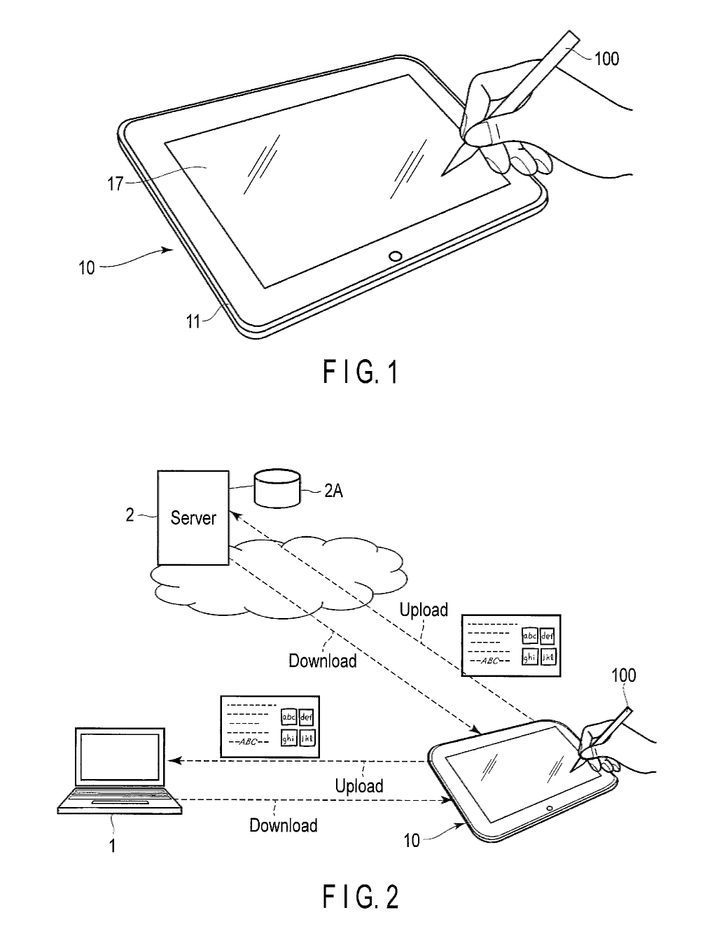

FIG. 1 is a perspective view showing an example of an appearance of an electronic apparatus according to one embodiment. The electronic apparatus is, for example, a stylus-based portable electronic apparatus in which handwriting input can be performed by a stylus or a finger. The electronic apparatus can be realized as a tablet computer, a notebook personal computer, a smartphone, a PDA, etc. Hereinafter, the case where the electronic apparatus is realized as a tablet computer 10 will be described. The tablet computer 10 is a portable electronic apparatus called a tablet or slate computer, and its main body 11 includes a housing in the shape of a thin box.

A touchscreen display 17 is mounted so as to be laid on the upper surface of the body 11. In the touchscreen display 17, a flat-panel display and a sensor configured to detect the contact position of a stylus or a finger on the screen of the flat-panel display are incorporated. The flat-panel display may be, for example, a liquid crystal display (LCD). As the sensor, for example, a capacitive touchpanel or an electromagnetic induction digitizer can be used. In the following, the case where two kinds of sensor, a digitizer and a touchpanel, are both incorporated in the touchscreen display 17 will be described. Therefore, the touchscreen display 17 can detect not only a touch operation on the screen with a finger but also a touch operation on the screen with a stylus 100.

The stylus 100 may be, for example, a digitizer stylus (electromagnetic induction stylus). The user can perform a handwriting input operation on the touchscreen display 17, using the stylus 100 (stylus input mode). In the stylus input mode, the path of movement of the stylus 100 on the screen, that is, strokes handwritten by the handwriting input operation are obtained, whereby the strokes input in handwriting are displayed on the screen. The path of movement of the stylus 100 made while the stylus 100 contacts the screen corresponds to one stroke. Strokes form a character, a symbol, etc. A set of many strokes corresponding to a handwritten character, a handwritten figure, a handwritten table, etc., constitutes a handwritten document.

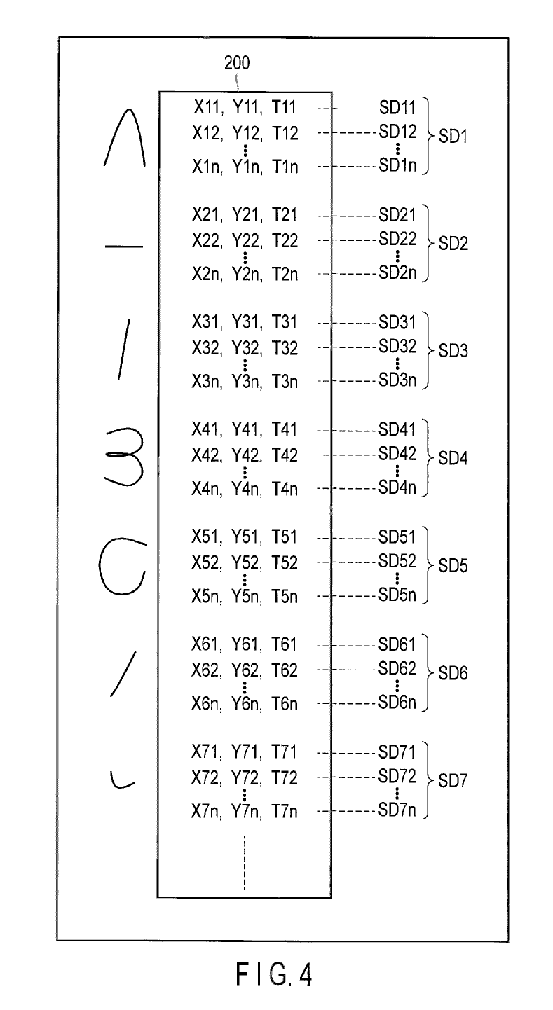

In the present embodiment, the handwritten document is saved on a storage medium, not as image data, but as a time-series data item (handwritten document data item) indicating a coordinate series of the path of each stroke and the order of strokes. However, the handwritten document may be prepared based on image data. The time-series data item, which will be described later in detail with reference to FIG. 4, indicates the order in which strokes were handwritten, and includes stroke data items corresponding to the strokes, respectively. In other words, the time-series data item means a set of time-series stroke data items corresponding to the strokes, respectively. Each stroke data item corresponds to one stroke, and includes a coordinate data series (time-series coordinates) corresponding to respective points on the path of the stroke. The order in which the stroke data items are arranged corresponds to the order in which the strokes were made.

The tablet computer 10 can read an arbitrary existing time-series data item from the storage medium, and display a handwritten document corresponding to the time-series data item, that is, strokes indicated by the time-series data item, on the screen. The strokes indicated by the time-series data item are also strokes input in handwriting.

Further, the tablet computer 10 according to the present embodiment also has a touch input mode for performing a handwriting input operation using a finger without using the stylus 100. When the touch input mode is effective, the user can perform a handwriting input operation on the touchscreen display 17 using a finger. In the touch input mode, the path of movement of the finger on the screen, that is, strokes handwritten by the handwriting input operation, are obtained, whereby the strokes input in handwriting are displayed on the screen.

The tablet computer 10 has an edit function. With the edit function, an arbitrary handwritten portion (handwritten character, handwritten mark, handwritten figure, handwritten table, etc.) in a displayed handwritten document selected by a range selection tool can be deleted or moved in accordance with an edit operation by the user with an eraser tool, the range selection tool, and various other tools. In addition, an arbitrary handwritten portion in a handwritten document selected by the range selection tool can also be designated as a search key for searching for the handwritten document. Moreover, a recognition process such as handwritten character recognition, handwritten figure recognition, or handwritten table recognition can also be performed for an arbitrary handwritten portion in a handwritten document selected by the range selection tool.

In the present embodiment, a handwritten document can be managed as one or more pages. In this case, a set of time-series data items within one screen may be stored as one page by dividing time-series data items (handwritten document data items) in units of an area within one screen. Alternatively, the size of a page may be variable. In this case, the size of a page can be expanded larger than the size of one screen, and thus, a handwritten document larger than the screen can be handled as one page. When the whole page cannot be displayed on the display at once, the page may be scaled down, or a portion to be displayed on the page may be moved by vertical and horizontal scrolling.

FIG. 2 shows an example of cooperation between the tablet computer 10 and external apparatuses. The tablet computer 10 includes a wireless communication device of a wireless LAN, etc., and can wirelessly communicate with a personal computer 1. Moreover, the tablet computer 10 can also communicate with a server 2 on the Internet 3, using the wireless communication device. The server 2 may be a server which performs an online storage service and various other cloud computing services.

The personal computer 1 includes a storage device such as a hard disk drive (HDD). The tablet computer 10 can transmit a time-series data item (handwritten document data item) to the personal computer 1, and store it on the HDD of the personal computer 1 (upload). To establish secure communication between the tablet computer 10 and the personal computer 1, the personal computer 1 may authenticate the tablet computer 10 when starting communication. In this case, a dialog which prompts the user to input an ID or a password may be displayed on the screen of the tablet computer 10, or the ID of the tablet computer 10, etc., may be automatically transmitted from the tablet computer 10 to the personal computer 1.

The tablet computer 10 thereby can handle a large number of time-series data items or a large volume of time-series data items, even if the capacity of storage in the tablet computer 10 is small.

Moreover, the tablet computer 10 can read one or more arbitrary time-series data items stored in the HDD of the personal computer 1 (download), and display strokes indicated by the read time-series data items on the screen of the display 17 of the tablet computer 10. In this case, a list of thumbnails obtained by scaling down respective pages of the time-series data items may be displayed on the screen of the display 17, or one page selected from the thumbnails may be displayed on the screen of the display 17 in a normal size.

Furthermore, the tablet computer 10 may communicate, not with the personal computer 1, but with the server 2 on a cloud which provides a storage service, etc., as described above. The tablet computer 10 can transmit a time-series data item (handwritten document data item) to the server 2 over the Internet, and store it in a storage device 2A of the server 2 (upload). Moreover, the tablet computer 10 can read an arbitrary time-series data item stored in the storage device 2A of the server 2 (download), and display the respective paths of strokes indicated by the time-series data item on the screen of the display 17 of the tablet computer 10.

In this manner, in the present embodiment, the storage medium on which time-series data items are saved may be any of the storage device in the tablet computer 10, the storage device in the personal computer 1, and the storage device in the server 2.

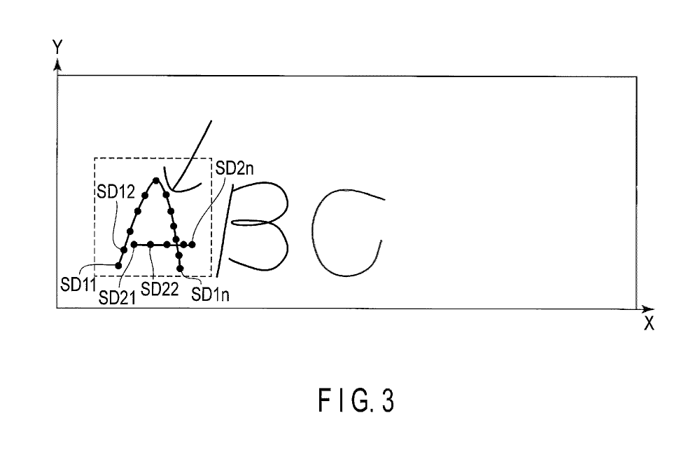

Next, a relationship between strokes (characters, figures, tables, etc.) handwritten by the user and a time-series data item will be described with reference to FIG. 3 and FIG. 4. FIG. 3 shows an example of a handwritten document (handwritten character string) handwritten on the touchscreen display 17 with the stylus 100 or the like.

In a handwritten document, a case often occurs where after a character, a figure, or the like is input in handwriting, another character, figure, or the like is further input thereon in handwriting. In FIG. 3, handwritten characters “A”, “B”, and “C” are input in handwriting in this order, and then, a handwritten arrow is input in handwriting close to the handwritten character “A”.

The handwritten character “A” is represented by two strokes (a path in the form of “Λ” and a path in the form of “-”) handwritten with the stylus 100 or the like, that is, two paths. The path “Λ” of the stylus 100 which is first handwritten is sampled in real time, for example, at regular time intervals, whereby time-series coordinates SD11, SD12, . . . , SD1n of the stroke “Λ” are obtained. Similarly, the path “-” of the stylus 100 which is handwritten next is also sampled in real time at regular time intervals, whereby time-series coordinates SD21, SD22, . . . , SD2n of the stroke “-” are obtained.

The handwritten character “B” is represented by two strokes handwritten with the stylus 100 or the like, that is, two paths. The handwritten character “C” is represented by one stroke handwritten with the stylus 100 or the like, that is, one path. The handwritten arrow is represented by two strokes handwritten with the stylus 100 or the like, that is, by two paths.

FIG. 4 shows a time-series data item 200 corresponding to the handwritten document of FIG. 3. The time-series data item includes stroke data items SD1, SD2, . . . , SD7. In the time-series data item 200, the stroke data items SD1, SD2, . . . , SD7 are chronologically arranged in the order in which strokes were handwritten.

In the time-series data item 200, the first and second stroke data items SD1 and SD2 indicate the two strokes of the handwritten character “A”, respectively. The third and fourth stroke data items SD3 and SD4 indicate the two strokes constituting the handwritten character “B”, respectively. The fifth stroke data item SD5 indicates the one stroke constituting the handwritten character “C”. The sixth and seventh stroke data items SD6 and SD7 indicate the two strokes constituting the handwritten arrow, respectively.

Each stroke data item includes a coordinate data series (time-series coordinates) corresponding to one stroke, that is, coordinates corresponding to respective sampling points on the path of one stroke. In each stroke data item, the coordinates of the sampling points are chronologically arranged in the order in which a stroke was written (sampled). For example, regarding the handwritten character “A”, the stroke data item SD1 includes a coordinate data series (time-series coordinates) corresponding to respective points on the path of the stroke “Λ” of the handwritten character “A”, that is, the n coordinate data items SD11, SD12, . . . , SD1n. The stroke data item SD2 includes a coordinate data series corresponding to respective points on the path of the stroke “-” of the handwritten character “A”, that is, the n coordinate data items SD21, SD22, . . . , SD2n. The number of coordinate data items may vary from stroke data item to stroke data item. If strokes are sampled at regular time intervals, the number of sampling points varies because the strokes differ in length.

Each coordinate data item indicates x- and y-coordinates corresponding to a point on a corresponding path. For example, the coordinate data item SD11 indicates an x-coordinate (X11) and a y-coordinate (Y11) of a start point of the stroke “Λ”. The coordinate data item SD1n indicates an x-coordinate (X1n) and a y-coordinate (Y1n) of an end point of the stroke “Λ”.

Furthermore, each coordinate data item may include timestamp data T corresponding to a point in time (sampling timing) when a point corresponding to coordinates was handwritten. The point in time when the point was handwritten may be an absolute time (for example, year, month, day, hour, minute, and second) or a relative time determined with respect to a certain point in time. For example, an absolute time (for example, year, month, day, hour, minute, and second) when a stroke started being written may be added to a each stroke data item as timestamp data, and a relative time indicating a difference from the absolute time may be further added to each coordinate data item in the stroke data items as timestamp data T.

In this manner, a temporal relationship between strokes can be more accurately indicated by using a time-series data item including timestamp data T added to each coordinate data item. Although not shown in FIG. 4, data (Z) indicating writing pressure may be added to each coordinate data item.

The time-series data item 200 having the structure as described with reference to FIG. 4 can indicate not only handwriting of each stroke but also a temporal relationship between strokes. Therefore, by using the time-series data item 200, the handwritten character “A” and a tip portion of the handwritten arrow can be handled as different characters or figures, even if the tip portion of the handwritten arrow is written to be superposed on the handwritten character “A” or close to the handwritten character “A” as shown in FIG. 3.

Furthermore, in the present embodiment, since a handwritten document data item is stored not as an image or a character recognition result but as the time-series data item 200 including a set of time-series stroke data items as described above, handwritten characters can be handled without depending on the language of the handwritten characters. Therefore, the structure of the time-series data item 200 of the present embodiment can be commonly used in various countries around the world where different languages are used.

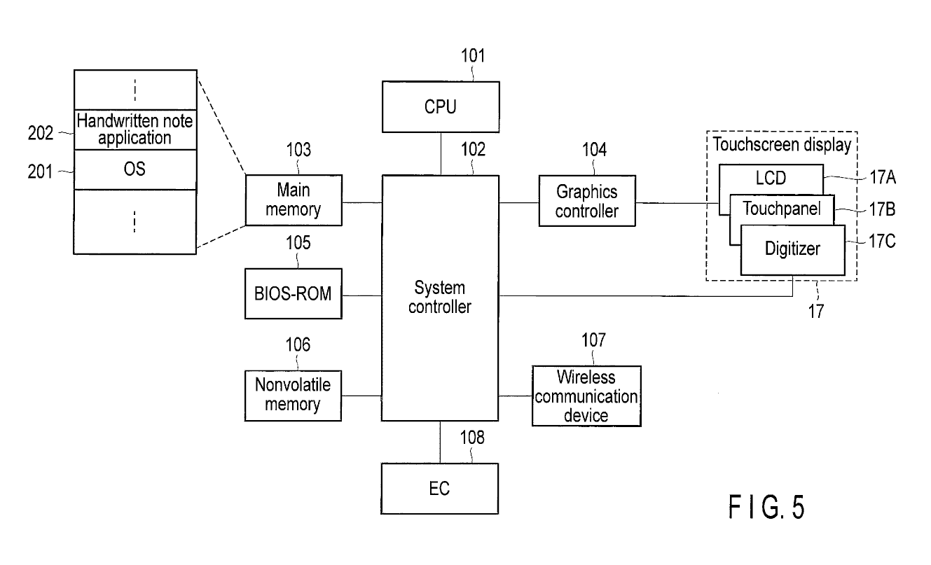

FIG. 5 is a diagram showing a system configuration of the tablet computer 10.

The tablet computer 10 includes a CPU 101, a system controller 102, a main memory 103, a graphics controller 104, a BIOS-ROM 105, a nonvolatile memory 106, a wireless communication device (receiver) 107, an embedded controller (EC) 108, etc.

The CPU 101 is a hardware processor which controls the operations of various modules in the tablet computer 10. The CPU 101 executes various items of software loaded from the nonvolatile memory 106, which is a storage device, into the main memory 103. The items of software include an operating system (OS) 201 and various application programs. The various application programs include a handwritten note application program 202. Hereinafter, a handwritten document data item may be also referred to as a handwritten note. The handwritten note application program 202 has the function of preparing and displaying the above-described handwritten document data item, the function of editing the handwritten document data item, and a handwritten document search function for searching for a handwritten document data item including a desired handwritten portion or a desired handwritten portion in a handwritten document data item.

The CPU 101 also executes a Basic Input/Output System (BIOS) stored in the BIOS-ROM 105. The BIOS is a program for hardware control.

The system controller 102 is a device which connects a local bus of the CPU 101 and various components and modules. The system controller 102 also contains a memory controller which exerts access control over the main memory 103. In addition, the system controller 102 also has the function of communicating with the graphics controller 104 through a serial bus conforming to the PCI EXPRESS standard, etc.

The graphics controller 104 is a display controller which controls an LCD 17A used as a display monitor of the tablet computer 10. A display signal generated by the graphics controller 104 is transmitted to the LCD 17A. The LCD 17A displays a screen image based on the display signal. The LCD 17A, a touchpanel 17B, and a digitizer 17C are superposed on each other. The touchpanel 17B is a capacitive pointing device for performing input on the screen of the LCD 17A. A contact position on the screen which a finger contacts, the movement of the contact position, etc., are detected by the touchpanel 17B. The digitizer 17C is an electromagnetic induction pointing device for performing input on the screen of the LCD 17A. A contact position on the screen which the stylus (digitizer stylus) 100 contacts, the movement of the contact position, etc., are detected by the digitizer 17C.

The wireless communication device 107 is a device configured to perform wireless communication such as wireless LAN or 3G mobile communication. The EC 108 is a single-chip microcomputer including an embedded controller for power management. The EC 108 has the function of powering the tablet computer 10 on or off in accordance with the user's operation of a power button.

Next, examples of representative screens presented to the user by the handwritten note application program 202 will be described.

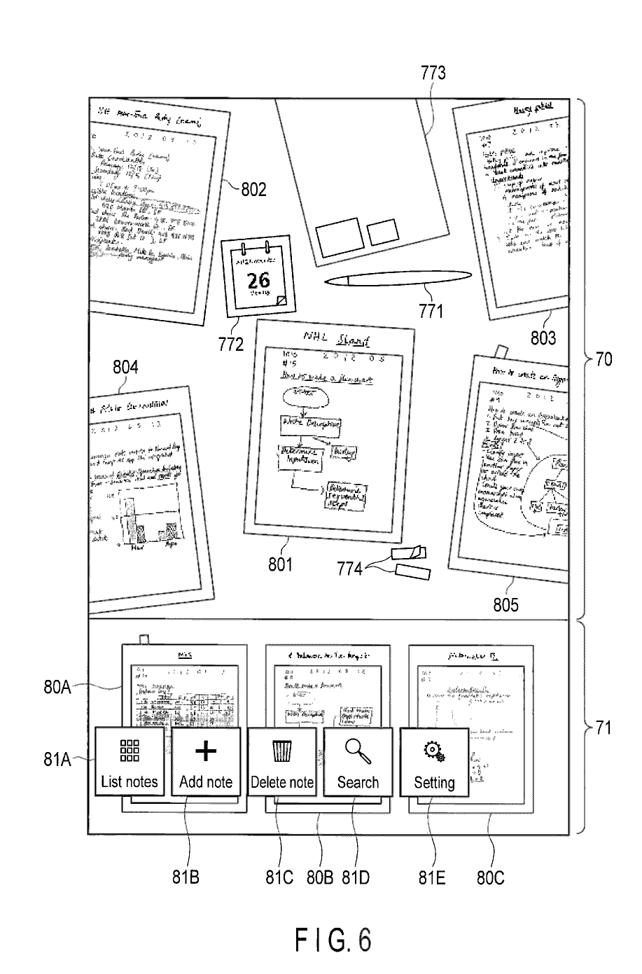

FIG. 6 shows an example of a home screen of the handwritten note application program 202. The home screen is a basic screen for handling handwritten document data items, and allows the management of notes, and the setting of the whole application.

The home screen includes a desktop screen area 70 and a drawer screen area 71. The desktop screen area 70 is a temporary area where note icons 801 to 805 corresponding to handwritten notes that is being worked on. The note icons 801 to 805 each display a thumbnail of a page in a corresponding handwritten note. In the desktop screen area 70, a pen icon 771, a calendar icon 772, a scrap note (gallery) icon 773, and a tag (label) icon 774 are further displayed.

The pen icon 771 is a graphical user interface (GUI) for switching a display screen from the home screen to a page edit screen. The calendar icon 772 is an icon showing the current date. The scrap note icon 773 is a GUI for viewing data (scrap data or gallery data) captured from other application programs or external files. The tag icon 774 is a GUI for attaching a label (tag) to an arbitrary page in an arbitrary handwritten note.

The drawer screen area 71 is a display area for viewing a storage area for storing all the handwritten notes that have already been prepared. In the drawer screen area 71, note icons 80A, 80B and 80C corresponding to several handwritten notes of all the handwritten notes are displayed. The note icons 80A, 80B, and 80C each display a thumbnail of a page in a corresponding handwritten note. The handwritten note application program 202 can detect a gesture (for example, a swipe gesture) in the drawer screen area 71 made by the user with the stylus 100 or a finger. In response to the detection of a gesture (for example, a swipe gesture), the handwritten note application program 202 scrolls a screen image in the drawer screen area 71 right or left. Notes icons corresponding to respective arbitrary handwritten notes can be thereby displayed in the drawer screen area 71.

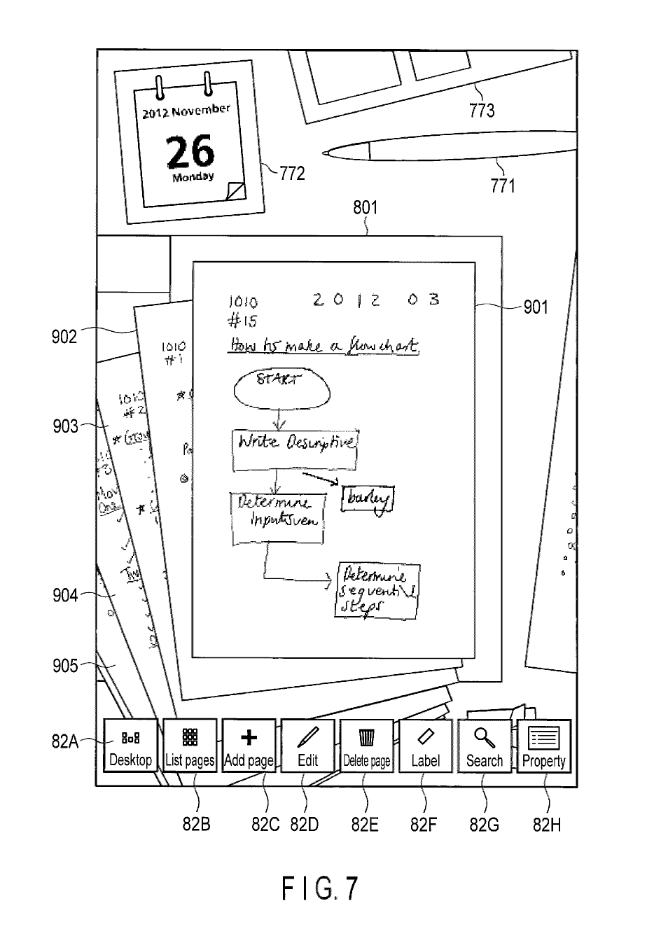

The handwritten note application program 202 can detect other gestures (for example, a tap gesture) on the note icons in the drawer screen area 71 made by the user with the stylus 100 or a finger. In response to the detection of a gesture (for example, a tap gesture) on a note icon in the drawer screen area 71, the handwritten note application program 202 moves the note icon to a central portion in the desktop screen area 70. In addition, the handwritten note application program 202 selects a handwritten note corresponding to the note icon, and displays a note preview screen shown in FIG. 7 instead of a desktop screen. The note preview screen of FIG. 7 is a screen on which an arbitrary page in the selected handwritten note can be viewed.

Moreover, the handwritten note application program 202 can also detect a gesture (for example, a tap gesture) in the desktop screen area 70 made by the user with the stylus 100 or a finger. In response to the detection of a gesture (for example, a tap gesture) on a note icon located at the central portion of the desktop screen area 70, the handwritten note application program 202 selects a handwritten note corresponding to the note icon located at the central portion, and displays the note preview screen shown in FIG. 7 instead of the desktop screen.

Moreover, a menu can be displayed on the home screen. The menu includes a note list button 81A, a note preparation button 81B, a note deletion button 81C, a search button 81D, and a setting button 81E displayed at the bottom of the screen, for example, in the drawer screen area 71. The note list button 81A is a button for displaying a list of handwritten notes. The note preparation button 81B is a button for preparing (adding) a new handwritten note. The note deletion button 81C is a button for deleting a handwritten note. The search button 81D is a button for opening a search screen (search dialog). The setting button 81E is a button for opening a setting screen of an application.

Although not shown in the figure, a return button, a home button, and a recent application button are also displayed under the drawer screen area 71.

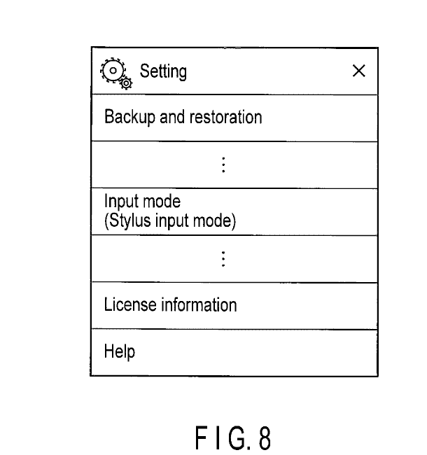

FIG. 8 shows an example of the setting screen which is opened if the setting button 81E is tapped with the stylus 100 or a finger.

On the setting screen, various setting items are displayed. The setting items include “Backup and restoration”, “Input mode” (stylus or touch input mode), “License information”, “Help”, etc.

If the note preparation button 81B is tapped with the stylus 100 or a finger on the home screen, a note preparation screen is displayed. Here, the name of a note is input to a title section in handwriting. A cover and a paper of the note can be selected. If the preparation button is pressed, a new note is prepared, and the prepared note is placed in the drawer screen area 71.

FIG. 7 shows an example of the above-described note preview screen.

The note preview screen is a screen on which an arbitrary page in a selected handwritten note can be viewed. Here, the case where a handwritten note corresponding to the note icon 801 in the desktop screen area 70 on the home screen is selected will be described. In this case, the handwritten note application program 202 displays pages 901, 902, 903, 904, and 905 included in the handwritten note in a form in which at least a part of each of the pages 901, 902, 903, 904 and 905 is viewable and the pages 901, 902, 903, 904 and 905 overlap each other.

On the note preview screen, the pen icon 771, the calendar icon 772, and the scrap note icon 773, described above, are further displayed.

On the note preview screen, a menu can be further displayed at the bottom of the screen. The menu includes a home button 82A, a page list button 82B, a page addition button 82C, a page edit button 82D, a page deletion button 82E, a label button 82F, a search button 82G, and a property display button 82H. The home button 82A is a button for closing a preview of a note and displaying the home screen. The page list button 82B is a button for displaying a list of pages in a currently selected handwritten note. The page addition button 82C is a button for preparing (adding) a new page. The edit button 82D is a button for displaying the page edit screen. The page deletion button 82E is a button for deleting a page. The label button 82F is a button for displaying a list of types of usable label. The search button 82G is a button for displaying a search screen. The property display button 82H is a button for displaying the property of the note.

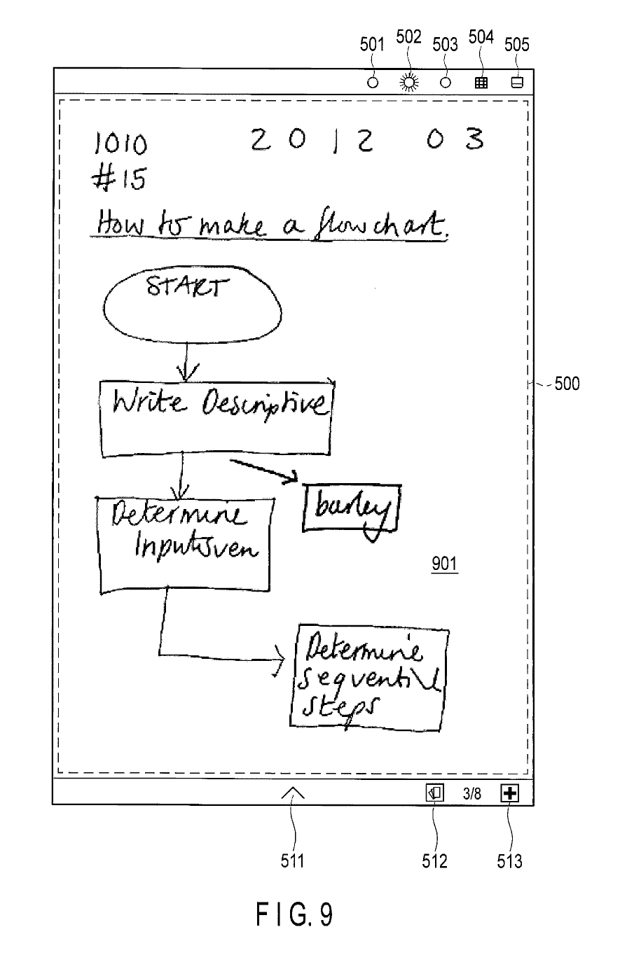

The handwritten note application program 202 can detect various gestures made by the user on the note preview screen. For example, in response to the detection of a gesture, the handwritten note application program 202 changes a page to be displayed on the top to an arbitrary page (page advance or page return). In addition, in response to the detection of a gesture (for example, a tap gesture) made on a page on the top, a gesture (for example, a tap gesture) made on the pen icon 771, or a gesture (for example, a tap gesture) made on the edit button 82D, the handwritten note application program 202 selects the page on the top and displays the page edit screen shown in FIG. 9 instead of the note preview screen.

The page edit screen of FIG. 9 is a screen on which a page (handwritten page) in a handwritten note can be newly prepared and an existing page can be viewed and edited. If the page 901 on the note preview screen of FIG. 7 is selected, the contents of the page 901 are displayed on the page edit screen as shown in FIG. 9.

On the page edit screen, a rectangular area 500 surrounded by a broken line is a handwriting input area where handwriting can be input. In the handwriting input area 500, an input event from the digitizer 17C is used to display (draw) a handwritten stroke, and is not used as an event indicating a gesture such as a tap. On the other hand, in the areas other than the handwriting input area 500 on the page edit screen, an input event from the digitizer 17C can also be used as an event indicating a gesture such as a tap.

An input event from the touchpanel 17B is not used to display (draw) a handwritten stroke, but is used as an event indicating a gesture such as a tap or a swipe.

On the page edit screen, a quick select menu including three types of pen 501 to 503 preregistered by the user, a range selection pen 504, and an eraser pen 505 is further displayed at the upper part of the screen outside the handwriting input area 500. Here, the case where the black pen 501, the red pen 502, and the highlighter 503 are preregistered by the user is described. The user can switch the type of pen to be used by tapping a pen (button) in the quick select menu with the stylus 100 or a finger. For example, if a handwriting input operation is performed with the stylus 100 on the page edit screen in a state in which the black pen 501 is selected by the user's tap gesture with the stylus 100 or a finger, the handwritten note application program 202 displays a black stroke (path) on the page edit screen in accordance with the movement of the stylus 100.

The above-described three types of pen in the quick select menu can also be switched by an operation of a side button (not shown in the figure) of the stylus 100. A frequently used combination of pen color and pen thickness can be set for each of the three types of pen in the quick select menu.

On the page edit screen, a menu button 511, a page return (return to the note preview screen) button 512, and a new page addition button 513 are further displayed at the bottom of the screen outside the handwriting input area 500. The menu button 511 is a button for displaying a menu.

In the menu, for example, buttons for putting the page into a recycle bin, pasting a part of a page that has been copied or cut, opening the search screen, displaying an export sub-menu, displaying an import sub-menu, converting a page into text and transmitting an email, and displaying a pen case, may be displayed. The export sub-menu, for example, causes the user to select the function of recognizing a handwritten page displayed on the page edit screen and converting it into an electronic document file, a presentation file, an image file, etc., or the function of converting the page into an image file and sharing it with other applications. The import sub-menu, for example, causes the user to select the function of importing a memo from a memo gallery, or the function of importing an image from the gallery. The pen case is a button for invoking a pen setting screen on which the color (the color of a line to be drawn) and the thickness (the thickness of a line to be drawn) of each of the three types of pen in the quick select menu can be changed.

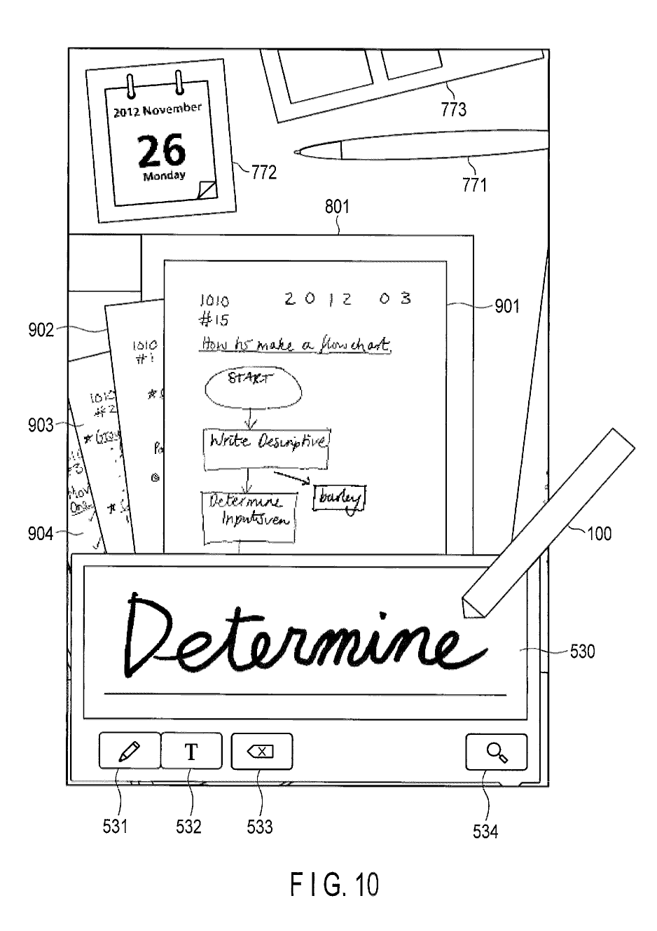

FIG. 10 shows an example of the search screen (search dialog). FIG. 10 explains the case where the search button 82G is selected on the note preview screen shown in FIG. 7, and the search screen (search dialog) is opened on the note preview screen.

On the search screen, a search key input area 530, a handwriting search button 531, a text search button 532, a deletion button 533, and a search conduct button 534 are displayed. The handwriting search button 531 is a button for selecting a handwriting search. The text search button 532 is a button for selecting a text search. The delete button 533 is a button for deleting a search key in the search key input region 530. The search conduct button 534 is a button for requesting a search process to be conducted.

In the handwriting search, the search key input area 530 is used as an input area for handwriting a character string, figure, table, etc., to be a search key. In FIG. 10, a handwritten character string “Determine” is input to the search key input area 530 as a search key. The user can handwrite not only a handwritten character string, but also a handwritten figure, a handwritten table, etc., in the search key input area 530 with the stylus 100. If the search conduct button 534 is selected by the user in a state in which the handwritten character string “Determine” is input to the search key input area 530 as a search key, the handwriting search is conducted, using a stroke set (query stroke set) constituting the handwritten character string “Determine”, to search for a handwritten document (note) including a stroke set corresponding to the query stroke set. In the handwriting search, a stroke set similar to the query stroke set is searched for by performing matching between strokes. Dynamic programming (DP) matching may be used to calculate the degree of similarity between the query stroke set and other stroke sets.

In the text search, for example, a software keyboard is displayed on the screen. The user can input an arbitrary text (character string) to the search key input area 530 as a search key by operating the software keyboard. If the search conduct button 534 is selected by the user in a state in which a text is input to the search key input area 530 as a search key, the text search is conducted to search for a handwritten note including a stroke set indicating the text (query text).

The handwriting search/text search may be conducted through all handwritten documents, or may be conducted only through a selected handwritten document. If the handwriting search/text search is conducted, a search result screen is displayed. On the search result screen, a list of handwritten documents (pages) including a stroke set corresponding to a query stroke set (or a query text) is displayed. A hit word (the stroke set corresponding to the query stroke set or the query text) is displayed with emphasis.

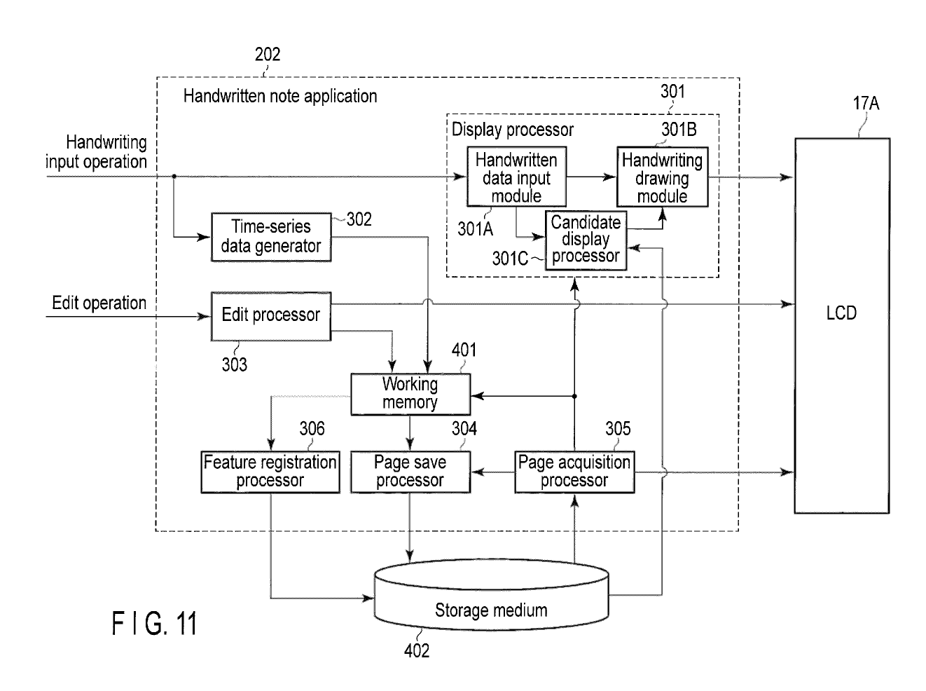

Next, a functional configuration of the handwritten note application program 202 will be described with reference to FIG. 11.

The handwritten note application program 202 is a WYSIWIG application which can handle handwritten document data items. The handwritten note application program 202 includes, for example, a display processor 301, a time-series data generator 302, an edit processor 303, a page save processor 304, a page acquisition processor 305, a feature registration processor 306, and a working memory 401. The display processor 301 includes a handwritten data input module 301A, a handwriting drawing module 301B, and a candidate display processor 301C.

The above-described touchpanel 17B is configured to detect the occurrence of events such as touch (contact), move (slide), and release. The touch (contact) event is an event indicating that an object (finger) contacted the screen. The move (slide) event is an event indicating that a contact position was moved while the object (finger) was in contact with the screen. The release event is an event indicating that the object (finger) was released from the screen.

The above-described digitizer 17C is also configured to detect the occurrence of events such as touch (contact), move (slide), and release. The touch (contact) event is an event indicating that an object (stylus 100) contacted the screen. The move (slide) event is an event indicating that a contact position moved while the object (stylus 100) was in contact with the screen. The release event is an event indicating that the object (stylus 100) was released from the screen.

The handwritten note application program 202 displays the page edit screen for preparing, viewing, and editing a handwritten page data item on the touchscreen display 17.

The display processor 301 and the time-series data generator 302 receive the touch (contact), move (slide), or release event generated by the digitizer 17C, thereby detecting a handwriting input operation. The touch (contact) event includes the coordinates of a contact position. The move (slide) event includes the coordinates of the contact position that was moved. Thus, the display processor 301 and the time-series data generator 302 can receive a coordinate string corresponding to the path of movement of the contact position from the digitizer 17C.

The display processor 301 displays a handwritten stroke on the screen in accordance with the movement of an object (stylus 100) on the screen detected by the digitizer 17C. The display processor 401 displays the path of the stylus 100 made while the stylus 100 is in contact with the screen, that is, the path of each stroke, on the page edit screen.

The time-series data generator 302 receives the above-described coordinate string output from the digitizer 17C, and generates a handwritten data item including a time-series data item (coordinate data series) having the structure as described above with reference to FIG. 4 on the basis of the coordinate string. The time-series data generator 302 temporarily saves the generated handwritten data item on the working memory 401.

The edit processor 303 performs a process for editing a currently displayed handwritten page. To be specific, the edit processor 303 performs an edit process including a process of adding a new stroke (a new handwritten character, a new handwritten mark, etc.) to the currently displayed handwritten page, a process of deleting or moving one or more strokes of displayed strokes, etc., in accordance with an edit operation and a handwriting input operation performed by the user on the touchscreen display 17. Moreover, the edit processor 303 updates a time-series data item in the working memory 401 to make a result of the edit process reflected in the displayed time-series data item.

The page save processor 304 saves a handwritten page data item including stroke data items corresponding to handwritten strokes on a handwritten page that is being prepared on a storage medium 402. The storage medium 402 may be, for example, a storage device in the tablet computer 10, or a storage device in the server 2.

The page acquisition processor 305 acquires an arbitrary handwritten page data item from the storage medium 402. The acquired handwritten page data item is transmitted to the display processor 301. The display processor 301 displays strokes corresponding to stroke data items included in the handwritten page data item on the screen.

If a handwritten document (data item) is saved on the storage medium 402 by the page save processor 304, the feature registration processor 306 converts all the strokes constituting the handwritten document into character strings (words) by performing a character recognition process for the stroke sets in the handwritten document. The feature registration processor 306 regards a character string into which strokes are converted as a keyword, and registers the keyword, a character recognition result of each stroke set which is obtained by adding up strokes in a stroke set converted into the keyword (that is, recognized as the keyword in the character recognition process) in a handwritten document one by one in chronological order, and the number of strokes of the stroke set, in a suggest feature table, associating them with each other. Moreover, the feature registration processor 306 registers a character string (keyword) into which a stroke set is converted and stroke data items corresponding the stroke set converted into the character string in a suggest keyword table, associating them with each other. The suggest feature table and the suggest keyword table are saved on, for example, the storage medium 402.

Next, the details of the display processor 301 shown in FIG. 11 will be described.

As described above, the touchscreen display 17 detects a touch operation on the screen with the touchpanel 17B or the digitizer 17C. The handwritten data input module 301A is a module which inputs (receives) a detection signal output from the touchpanel 17B or the digitizer 17C. The detection signal includes a coordinate data item (X, Y) on a touch position. By inputting such detection signals in chronological order, the handwritten data input module 301A inputs a stroke data item corresponding to a handwritten stroke. The stroke data item (detection signal) input by the handwritten data input module 301A is supplied to the handwriting drawing module 301B.

The handwriting drawing module 301B is a module which draws the path (handwriting) of handwriting input and displays it on the LCD 17A of the touchscreen display 17. The handwriting drawing module 301B draws a segment corresponding to the path (handwriting) of handwriting input on the basis of a stroke data item (detection signal) from the handwritten data input module 301A.

If a stroke data item input by the handwritten data input module 301A corresponds to a stroke handwritten on the above-described page edit screen (the above-described handwriting input area 500), the stroke data item is also supplied to the candidate display processor 301C. If a stroke data item is input by the handwritten data input module 301A in this manner, the candidate display processor 301C displays a stroke set identified based on one or more handwritten strokes (that is, a stroke data item which was input at a point in time when the stroke data item supplied from the handwritten data input module 301A was input) in a candidate display area on the page edit screen as a candidate for handwriting input by the user. Stroke sets displayed as candidates for handwriting input indicate, for example, handwritten character strings, and include a stroke set (first stroke set) corresponding to the form of one or more (handwritten) strokes and the number of the one or more strokes, and a stroke set (second stroke set) corresponding to the form of one or more strokes and a number differing from the number of one or more strokes. In other words, the stroke sets (handwriting candidates) includes a first handwriting candidate including second strokes representing a first character made on document and a third stroke representing a second character and a second handwriting candidate including fourth strokes representing the first character and a fifth stroke representing a third character. A stroke count of the second strokes is the first number and a stroke count of the fourth strokes is a second number different from the first number. These stroke sets (handwriting candidates) are identified, referring to the above-described suggest feature table and suggest keyword table saved on the storage medium 402, as will be described later.

In the following description, a stroke set displayed as a candidate for handwriting input in the candidate display area on the page edit screen will be merely referred to as a handwriting input candidate. A specific example of the candidate display area where a handwriting input candidate is displayed will be described later.

If a handwriting input candidate is displayed in the candidate display area on the page edit screen in this manner, the user can select (designate) the handwriting input candidate as a character string, etc., to be displayed (written) in the handwriting input area 500. If a handwriting input candidate displayed in the candidate display area is selected by the user, the handwriting drawing module 301B displays the handwriting input candidate in the handwriting input area 500 on the page edit screen. At this time, the handwriting drawing module 301B displays the handwriting input candidate in the handwriting input area 500 on the basis of the coordinates of the handwriting input candidate (stroke set) displayed in the candidate display area. The coordinates of the stroke set are relatively determined with respect to time-series coordinates included in an already input stroke data item (that is, a stroke already handwritten in the handwriting input area 500).

Although not shown in FIG. 11, the handwritten note application program 202 includes a search processor for conducting the above-described handwriting search and text search, etc., in addition to those described above.

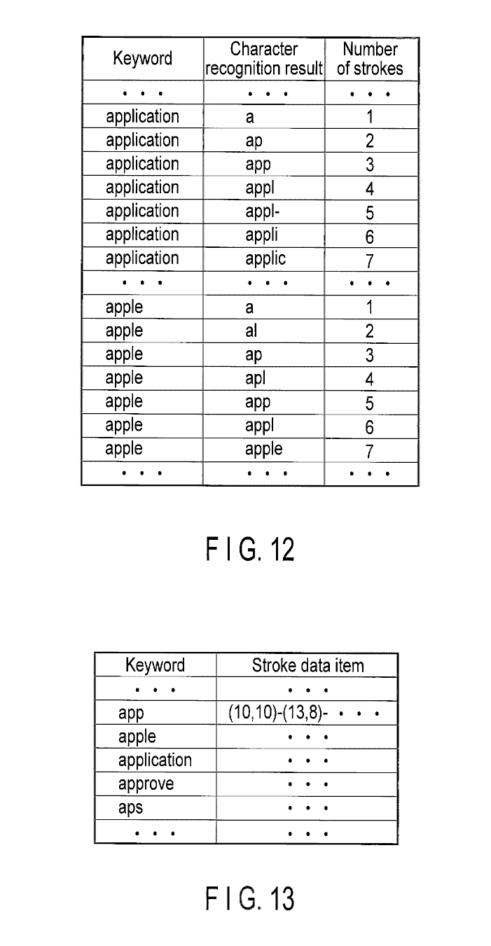

FIG. 12 shows an example of a data structure of the suggest feature table saved on the storage medium 402. As shown in FIG. 12, in the suggest feature table, a keyword, a character recognition result, and the number of strokes are held (registered), being associated with each other. The keyword is a character string (text) corresponding to the above-described handwriting input candidate. The character recognition result is a character recognition result of some of stroke sets which are recognized as a keyword associated with the character recognition result. The number of strokes is the number of strokes (that is, the stroke count) of a stroke set for which a character recognition result associated with the number of strokes was obtained.

In the example shown in FIG. 12, for example, a keyword “application”, a character recognition result “a”, and the number of strokes “1” are held in the suggest feature table, being associated with each other. This indicates that if a stroke set recognized as the keyword “application” was handwritten by the user, a character recognition result obtained by performing a character recognition process at a point in time when one stroke was handwritten is “a”.

In addition, for example, the keyword “application”, a character recognition result “ap”, and the number of strokes “2” are held in the suggest feature table, being associated with each other. This indicates that if the stroke set recognized as the keyword “application” was handwritten by the user, a character recognition result obtained by performing a character recognition process at a point in time when two strokes were handwritten is “ap”.

It is assumed that in the stroke set recognized as the keyword “application”, the characters “a” and “p” were each handwritten with one stroke.

In this manner, a character recognition result which is obtained whenever the number of strokes (that is, the stroke count) constituting the keyword “application” increases by one is held in the suggest feature table.

Moreover, in the example shown in FIG. 12, for example, a keyword “apple”, a character recognition result “a”, and the number of strokes “1” are held in the suggest feature table, being associated with each other. This indicates that if a stroke set recognized as the keyword “apple” was handwritten by the user, a character recognition result obtained by performing a character recognition process at a point in time when one stroke was handwritten is “a”.

In addition, for example, the keyword “apple”, a character recognition result “al”, and the number of strokes “2” are held in the suggest feature table, being associated with each other. This indicates that if the stroke set recognized as the keyword “apple” was handwritten by the user, a character recognition result obtained by performing a character recognition process at a point in time when two strokes were handwritten is “al”.

In addition, for example, the keyword “apple”, a character recognition result “ap”, and the number of strokes “3” are held in the suggest feature table, being associated with each other. This indicates that if the stroke set recognized as the keyword “apple” was handwritten by the user, a character recognition result obtained by performing a character recognition process at a point in time when three strokes were handwritten is “ap”.

It is assumed that in the stroke set recognized as the keyword “apple”, the character “a” was handwritten with one stroke and the character “p” was handwritten with two strokes.

In this manner, a character recognition result which is obtained whenever the number of strokes (that is, the stroke count) constituting the keyword “apple” increases by one is held in the suggest feature table.

That is, in the suggest feature table, a character recognition result of each stroke set which is obtained by adding up strokes in a stroke set recognized as a keyword one by one in chronological order, and the number of strokes of the stroke set are held, being associated with the keyword, as described above.

If a handwriting input candidate is displayed as described above, a search is conducted, using a character recognition result and the number of strokes (that is, the stroke count) as a key, which will be described later in detail.

Although the description has been herein concerned with the keywords “application” and “apple”, the character recognition results and the stroke counts of other keywords are also similarly held in the suggest feature table, being associated with the keywords.

FIG. 13 shows an example of a data structure of the suggest keyword table saved on the storage medium 402. As shown in FIG. 13, a keyword to be a main key and a stroke data item are held (registered) in the suggest keyword table, being associated with each other. The keyword is a character string (text) corresponding to the above-described handwriting input candidate. The stroke data item is a data item corresponding to a stroke set recognized as a keyword associated with the stroke data item (binary data item on the stroke).

In the example shown in FIG. 13, for example, a keyword “app” and a stroke data item “(10,10)-(13,8)- . . . ” are held in the suggest keyword table, being associated with each other. This indicates that a stroke data item corresponding a stroke set recognized as the keyword “app” is “(10,10)-(13,8)- . . . ” As described above, a stroke data item include coordinates corresponding to respective sampling points on the path of a stroke.

Although the description has been herein concerned with the keyword “app”, the stroke data items on other keywords (for example, “apple”, “application”, “approve”, and “aps”) are similarly held in the suggest keyword table, being associated with the keywords.

Hereinafter, the operation of the tablet computer 10 according to the present embodiment will be described. Of the processes performed by the tablet computer 10 according to the present embodiment, a feature registration process and a candidate display process will be herein described.

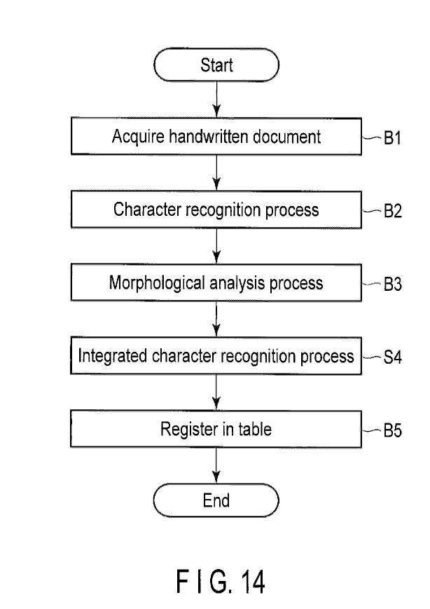

First, a procedure of the feature registration process will be described with reference to the flowchart of FIG. 14. The feature registration process is performed by the feature registration processor 306 if the above-described handwritten document (data item) is saved on the storage medium 402.

In the feature registration process, the feature registration processor 306 acquires a handwritten document from, for example, the working memory 401, if the handwritten document is saved on the storage medium 402 by the page save processor 304 (block B1). The handwritten document includes a stroke set handwritten by the user in the handwriting input area 500 on the above-described page edit screen, and includes stroke data items corresponding to the stroke set.

Next, the feature registration processor 306 performs a character recognition process for (the stroke set corresponding to the stroke data items included in) the acquired handwritten document (block B2). The stroke set constituting the handwritten document is thereby converted into a character string. At this time, (the stroke data items corresponding to) the respective strokes constituting the handwritten document are associated with characters which the strokes belong to (characters which are constituted of the strokes) in the character string into which the stroke set was converted by performing the character recognition process.

The feature registration processor 306 performs a morphological analysis process for the character string (block B3). The character string is thereby divided in units of words. At this time, the feature registration processor 306 identifies stroke sets belonging to the respective words into which the character string was divided by the morphological analysis process on the basis of the strokes associated with the respective characters in the above-described character string.

Next, the feature registration processor 306 performs an integrated character recognition process for the stroke sets belonging to the respective words into which the character string was divided by the morphological analysis process (block B4). The integrated character recognition process is a process of obtaining a character recognition result (character string) to be a feature amount for each stroke.

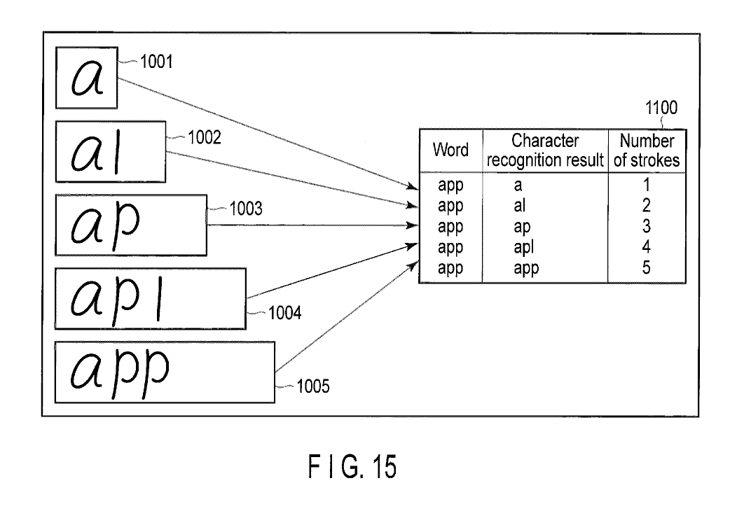

The integrated character recognition process will be herein specifically described with reference to FIG. 15. For convenience, the case where the integrated character recognition process is performed for stroke sets belonging to a word “app” representing an application, for example, will be herein described. In the example shown in FIG. 15, it is assumed that the character “a” was handwritten with one stroke and the character “p” was handwritten with two strokes.

In this case, a character recognition result obtained by performing a character recognition process for a stroke (set) 1001, the number of strokes (stroke count) of which is one, is “a”.

Next, a character recognition result obtained by performing a character recognition process for a stroke set 1002, the number of strokes (stroke count) of which is two, is “al”.

Similarly, a character recognition result obtained by performing a character recognition process for a stroke set 1003, the number of strokes (stroke count) of which is three, is “ap”.

Moreover, a character recognition result obtained by performing a character recognition process for a stroke set 1004, the number of strokes (stroke count) of which is four, is “apl”.

Finally, a character recognition result obtained by performing a character recognition process for a stroke set 1005, the number of strokes (stroke count) of which is five, is “app”.

If the integrated character recognition process is performed for the stroke sets belonging to the word “app” as described above, an integrated character recognition result 1100 shown in FIG. 15 can be obtained. The integrated character recognition result 1100 includes the word, the character recognition results corresponding to the stroke sets, and the numbers of strokes of the stroke sets.

Although the integrated character recognition process has been described as being performed for stroke sets belonging to one word in block B4, the integrated character recognition process may be performed for a character string including a plurality of words which can be handled as one set.

Referring to FIG. 14 again, the feature registration processor 306 registers various data items in the above-described suggest feature table and suggest keyword table on the basis of the obtained integrated character recognition result 1100 (block B5).

Specifically, the feature registration processor 306 registers the word (keyword), the character recognition results, and the numbers of strokes included in the integrated character recognition result 1100, in the suggest feature table, associating them with each other. In addition, the feature registration processor 306 registers the word (keyword) included in the integrated character recognition result 1100 and stroke data items corresponding to the stroke sets belonging to the word in the suggest keyword table.

In block B5, if the same data item (for example, a keyword) is already registered in the suggest feature table and the suggest keyword table, a registration process of the data item is omitted.

As described above, according to the feature registration process, if a handwritten document is saved on the storage medium 402, necessary data items used in the candidate display process, which will be described later, can be automatically registered in the suggest feature table and the suggest keyword table.

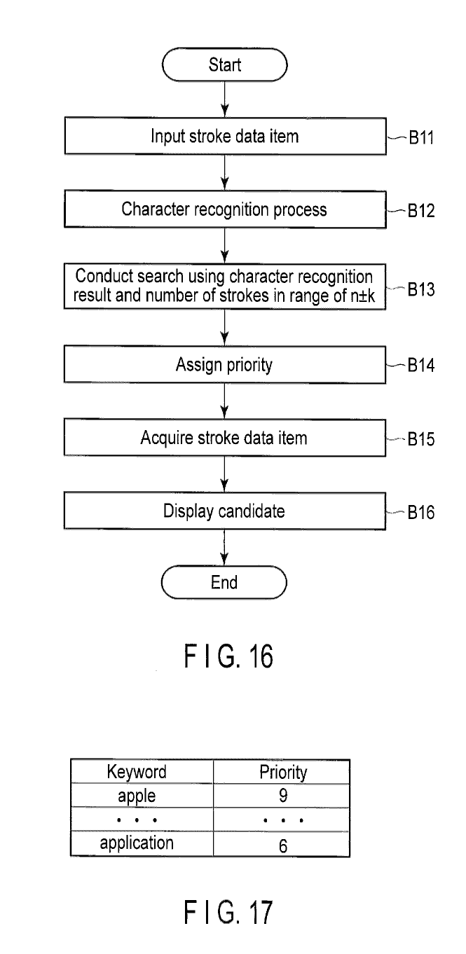

Next, a procedure of the candidate display process will be described with reference to the flowchart of FIG. 16. The candidate display process is performed by the candidate display processor 301C if a stroke data item corresponding to a stroke handwritten in the handwriting input area 500 on the above-described page edit screen is input. In addition, the candidate display process is performed whenever one stroke is handwritten in the handwriting input area 500.

In the candidate display process, the candidate display processor 301C inputs a stroke data item corresponding to one stroke handwritten by the user in the handwriting input area 500 on the page edit screen (block B11). A stroke data item input in block B11 will be hereinafter referred to as a target stroke data item.

Next, the candidate display processor 301C performs a character recognition process for a stroke set corresponding to a stroke data item which is already input at a point in time when a target stroke data item is input (that is, one or more strokes handwritten in the handwriting input area 500) (block B12). Specifically, if the target stroke data item is, for example, a stroke data item corresponding to an n^{th} stroke (n is an integer greater than or equal to one) of a handwritten character string, the candidate display processor 301C performs a character recognition process for a stroke set of first to n^{th} strokes. The candidate display processor 301C thereby obtains a character recognition result. In the present embodiment, the character recognition result is used as a feature (amount) of (the form of) the stroke set of the first to n^{th} strokes.

The first stroke is identified based on, for example, the positions of other strokes handwritten in the handwriting input area 500.

In the following description, it is assumed that the target stroke data item is a stroke data item corresponding to the n^{th} stroke of the handwritten character string (that is, the number of handwritten strokes is n).

The candidate display processor 301C searches the suggest feature table for a keyword on the basis of the obtained character recognition result and the number of strokes (here, n) of the stroke set for which the character recognition result was obtained. In this case, the candidate display processor 301C searches for a keyword, using the character recognition result and the numbers of strokes (stroke count) in the range of n±k (k is an integer greater than or equal to one) (block B13). In other words, the candidate display processor 301C searches for a keyword, using the character recognition result and the numbers of strokes in the range of n−k to n+k.

The process of block B13 will be herein described in detail. In this case, the candidate display processor 301C performs a search process (close number search) using the number of strokes n and the number of strokes close to the number of strokes n (the number of strokes differing from the number of strokes n). Specifically, if the above value k is one, the candidate display processor 301C searches for a keyword which is held in the suggest feature table, being associated with the obtained character recognition result and the number of strokes (stroke count) n, and for a keyword which is held in the suggest feature table, being associated with the character recognition result and the numbers of strokes n±1 (that is, the numbers of strokes n+1 and n−1).

In addition, if the value k is two, the candidate display processor 301C searches for a keyword which is held in the suggest feature table, being associated with the obtained character recognition result and the number of strokes n, for a keyword which is held in the suggest feature table, being associated with the character recognition result and the numbers of strokes n±1 (that is, the numbers of strokes n+1 and n−1), and for a keyword which is held in the suggest feature table, being associated with the character recognition result and the numbers of strokes n±2 (that is, the numbers of strokes n+2 and n−2).

The case where the value k is one or two has been herein described; however, even if the value k is greater than or equal to three, a keyword is similarly searched for, using the numbers of strokes in the range of n±k (that is, n−k to n+k). In the process of block B13, a plurality of keywords may be searched for.

In addition, if the value k is large, the number of keywords to be searched for increases. Thus, the value k can be changed as appropriate in accordance with the user's request. Moreover, although the value k has been described as an integer greater than or equal to one, the value k can also be set to zero.

Next, the candidate display processor 301C assigns priority to each keyword which was searched for (block B14). The priority of each keyword is assigned in accordance with the number of strokes (that is, the stroke count) of a stroke set for which a character recognition result was obtained.

The candidate display processor 301C acquires stroke data items corresponding to a stroke set constituting a keyword which was searched for (block B15). Specifically, the candidate display processor 301C acquires stroke data items which are held in the suggest keyword table, being associated with the keyword which was searched for.

The candidate display processor 301C displays a handwriting input candidate by drawing (the stroke set corresponding to) the acquired stroke data items in the candidate display area on the page edit screen (block B16). The handwriting input candidate is displayed based on the priority assigned to each keyword in block B14.

The keyword associated with the stroke data items acquired in block B15 was searched for through the suggest feature table, using the numbers of strokes in the range of n±k as described above. That is, the handwriting input candidates (stroke sets) displayed by the candidate display processor 301C include a stroke set corresponding to the character recognition result (the form of one or more strokes) obtained in block B12 and the number of strokes (for example, n) of the stroke set for which the character recognition result was obtained, and a stroke set corresponding to the character recognition result and the number of strokes differing from the number of strokes n (for example, the numbers of strokes other than n in the range of n±k).

The above-described candidate display process will be herein specifically described. It is herein assumed that in block B11, a stroke data item corresponding to a third stroke handwritten in the handwriting input area 500 was input, and a result obtained by performing a character recognition process for a stroke set of first to third strokes is “ap”. That is, it is herein assumed that the character “a” was handwritten with one stroke, and the character “p” was handwritten with two strokes. In addition, it is assumed that the suggest feature table shown in FIG. 12 is saved on the storage medium 402. Moreover, it is assumed that the above-described value k in block B13 is one.

In this case, the candidate display processor 301C searches for a keyword which is held in the suggest feature table, being associated with the character recognition result “ap” and the numbers of strokes in the range of 3±1, where the number of one or more strokes handwritten in the handwriting input area 500 is three (that is, the numbers of strokes in the range of two to four).

Here, in the suggest feature table shown in FIG. 12, the keyword “apple” is held, being associated with the character recognition result “ap” and the stroke count “3”. Thus, the candidate display processor 301C acquires the keyword “apple” as a result of searching for a keyword which is held in the suggest feature table, being associated with the character recognition result “ap” and the stroke count “3”.

In addition, in the suggest feature table shown in FIG. 12, the keyword “application” is held, being associated with the character recognition result “ap” and the stroke count “2”. Thus, the candidate display processor 301C acquires the keyword “application” as a result of searching for a keyword which is held in the suggest feature table, being associated with the character recognition result “ap” and the stroke count “2”.

Also, in the suggest feature table shown in FIG. 12, no keyword is held, being associated with the character recognition result “ap” and the stroke count “4”. Thus, a keyword which is held in the suggest feature table, being associated with the character recognition result “ap” and the stroke count “4”, is not searched for.

Next, the candidate display processor 301C assigns priority to the keywords “apple” and “application” obtained as search results.

Here, the number of strokes (that is, the stroke count) handwritten by the user is used as the priority assigned to the keywords. In the example given herein, because the third stroke is handwritten by the user, the priority “3” is assigned to each of the keywords “apple” and “application” obtained as search results as described above.

In addition, in the present embodiment, the priority of a keyword associated with the number of handwritten strokes (here, three) (that is, the keyword “apple”) is higher than that of a keyword associated with to a number differing from the number of strokes (that is, the keyword “application”). In this case, a coefficient according to a difference from the number of handwritten strokes is predetermined, and a value obtained by multiplying the number of strokes (that is, the priority assigned to each keyword) by the coefficient is used as priority. Specifically, a coefficient used when the difference from the number of handwritten strokes is 0 is 3, a coefficient used when the difference is ±1 is 2, and a coefficient used when the difference is ±2 is 1. According to this, the priority of the keyword “apple” is 3×3=9 as shown in FIG. 17. On the other hand, the priority of the keyword “application” is 3×2=6.

Although it has been herein explained that the number of handwritten strokes is multiplied by a coefficient, a constant other than the number of strokes or priority assigned by other methods may be multiplied by the above-described coefficient.

Also, a stroke set (that is, a handwriting input candidate) constituting a keyword obtained as a search result is displayed in the candidate display area based on priority assigned to the keyword.

In the present embodiment, since the above-described priority is assigned, (a stroke set constituting) a keyword whose difference from the number of handwritten strokes is small can be displayed with higher priority than (a stroke set constituting) a keyword whose difference is large.

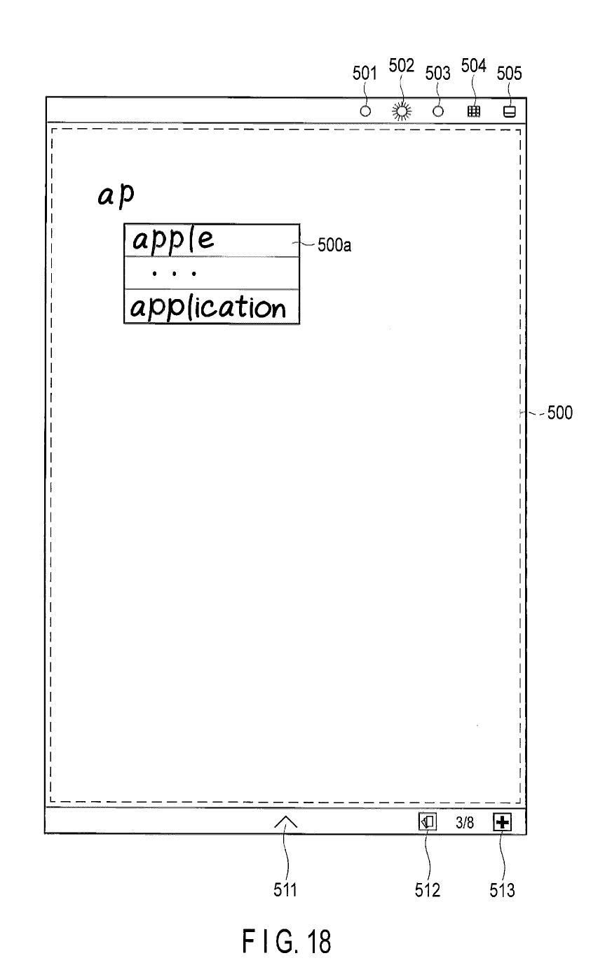

The candidate display area where handwriting input candidates are displayed will be herein specifically described with reference to FIG. 18. The same portions as those of FIG. 9 are herein given the same numbers, and detailed explanations thereof are omitted.

As described above, priority is assigned to each keyword. However, in the following description, for convenience, it is assumed that priority is assigned to handwriting input candidates which are stroke sets constituting the keywords.

As shown in FIG. 18, it is herein assumed that the user handwrote a character string “ap” in the handwriting input area 500 on the page edit screen with three strokes. In this case, on the page edit screen, a candidate display area 500a is displayed. In addition, in the candidate display area 500a, handwriting input candidates are displayed according to priority assigned at a point in time when a third stroke was handwritten.

In the example shown in FIG. 18, in the candidate display area 500a, handwriting input candidates whose priority (value) shown in FIG. 17 is high (that is, stroke sets constituting keywords to which high priority is assigned) are displayed in order from the top.

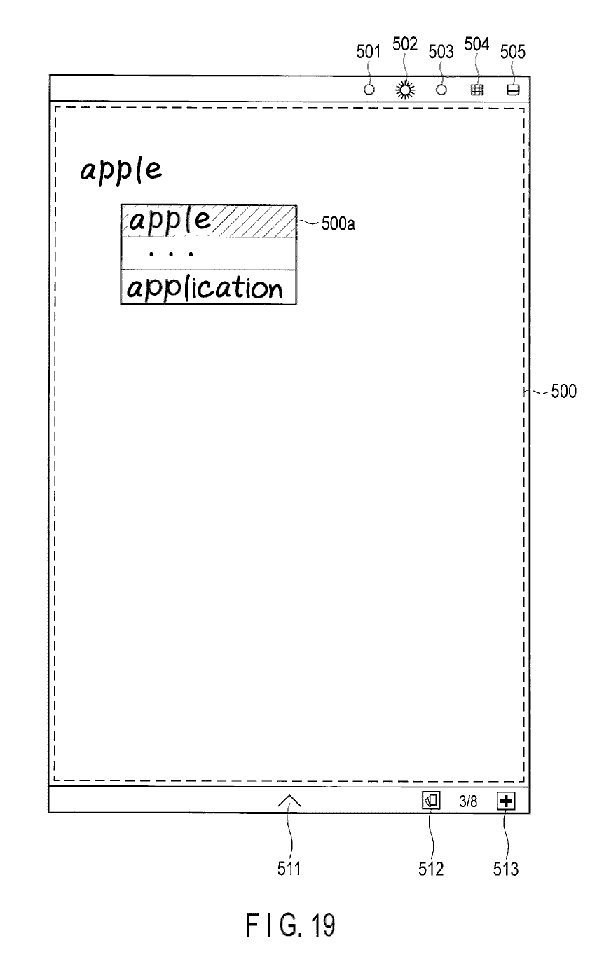

Here, the user can select (designate) one of the handwriting input candidates displayed in the candidate display area 500a on the page edit screen shown in FIG. 18. If one of the handwriting input candidates is selected in this manner, the handwriting input candidate is displayed in the handwriting input area 500. FIG. 19 shows an example of the display screen (handwriting input area 500) in the case where a handwriting input candidate “apple” is selected from the handwriting input candidates displayed in the candidate display area 500a.

Also, in the candidate display area 500a, all the handwriting input candidates may be displayed, or, for example, only a handwriting input candidate whose priority is greater than or equal to a predetermined value may be displayed. In addition, if only the handwriting input candidate whose priority is greater than or equal to the predetermined value is displayed, it is possible to change the above-described coefficient in accordance with the user's request. Specifically, it is also possible to increase the coefficient (that is, increase priority) if the user wants to increase the number of displayed handwriting input candidates, or decrease the coefficient (that is, decrease priority) if the user want to decrease the number of displayed handwriting input candidates.

In addition, it is also possible to display handwriting input candidates in the candidate display area 500a in forms differing according to priority. Specifically, the user can easily ascertain the order of priority (or the priority) of handwriting input candidates by changing the color, size, thickness, etc., between a handwriting input candidate of high priority and a handwriting input candidate of low priority.

Since the candidate display process is performed whenever a stroke is handwritten in the handwriting input area 500 as described above, an appropriate handwriting input candidate can be displayed (that is, updated) whenever a stroke is handwritten.

As described above, in the present embodiment, a stroke set corresponding to the form of one or more handwritten strokes and the number of one or more strokes (that is, a first handwriting candidate including second strokes representing a first character whose stroke count is a first number), and a stroke set corresponding to the form of the one or more strokes and a number differing from the number of one or more strokes (that is, a second handwriting candidate including fourth strokes representing the first character whose stroke count is a second number different from the first number) are displayed as handwriting input candidates. In the present embodiment, by virtue of this structure, the user does not need to write all the character strings by hand when preparing a handwritten document, and it is possible to save the user trouble. Thus, the user's preparation of a handwritten document can be facilitated.

In addition, in the present embodiment, even if a keyword associated with a character recognition result of one or more handwritten strokes (that is, the form of the one or more strokes) and the number of one or more strokes (that is, the stroke count) (that is, a keyword corresponding to a handwriting input candidate) is not registered in the suggest keyword table, a handwriting input candidate can be displayed, provided that a keyword corresponding to the character recognition result and the number of strokes differing from the above number of strokes is registered in the suggest keyword table.

To be specific, let us assume the case where the user handwrote the character “p” with two strokes if writing, for example, the character string “application” although the user usually writes the character “p” with one stroke. According to the present embodiment, even in such a case, “application” can be displayed as a handwriting input candidate.

Accordingly, in the present embodiment, an appropriate handwriting input candidate can be searched for and displayed, even if the user forgets to write strokes of a predetermined stroke count or writes an unnecessary stroke (for example, a dot) when the user handwrites a character string (that is, even if the stroke count of a character varies).

In addition, in the present embodiment, a coefficient according to a difference from the number of handwritten strokes is used. Accordingly, a stroke set associated with the number of strokes can be displayed with higher priority than a stroke set associated with a number differing from the number of strokes. Moreover, a stroke set corresponding to a number whose difference is small can be displayed with higher priority than a stroke set corresponding to a number whose difference is large.

In the present embodiment, it has been explained that a value obtained by multiplying the number of handwritten strokes by a coefficient is used as priority; however, for example, the number of strokes can be merely used as priority. Accordingly, a handwriting input candidate identified when the number of strokes is large can be displayed with higher priority, considering the fact that in general, the larger the number of characters (the number of strokes) is, the more it is likely to be a candidate intended by the user.

In addition, if the user handwrites, for example, a complex kanji, the kanji (character) may be obtained as a character recognition result even if the number of strokes (stroke count) is small (if the user does not finish writing the kanji or if one stroke is dropped). In such a case, to present an appropriate handwriting input candidate (kanji) to the user, it is necessary to display a stroke set (handwriting input candidate) constituting a keyword which was searched for, using the number of strokes n+k with higher priority. Thus, by determining a coefficient which allows a stroke set corresponding to a number greater than the number of handwritten strokes to be displayed with higher priority than a stroke set corresponding to a number less than the number of handwritten strokes, a stroke set (handwriting input candidate) constituting a keyword which was searched for using the number of strokes n+k can be displayed with higher priority than a stroke set constituting a keyword which was searched for using the number of strokes n−k. The case where a kanji, etc., are handwritten has been herein described; however, for example, if a character string of letters of the alphabet is handwritten, the case where a character string that is usually continuously handwritten is written separately is assumed. In such a case, for example, a stroke set constituting a keyword which was searched for using the number of strokes n−k may be displayed with higher priority.

In addition, in the present embodiment, it has been explained that the priority of a keyword which was searched for when a stroke data item corresponding to an n^{th} stroke was input is a value obtained by multiplying the number of strokes (that is, n) by a coefficient; however, a value obtained by adding n (or a value obtained by multiplying n by a coefficient) to the priority assigned to first to n−1^{th} strokes of the keyword may be assigned to the keyword as the priority. According to this, handwriting input candidates can be displayed according to the priority in which the priority assigned to the first to n−1^{th} strokes is reflected.

Because the processes of the present embodiment can be implemented by a computer program, the same advantages as those of the present embodiment can be easily achieved by installing the computer program in a computer through a computer-readable storage medium storing the computer program and executing the computer program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method comprising:
displaying a document stored in a memory on a screen;
receiving first strokes representing a first character made on document displayed on the screen, wherein a stroke count of the first strokes is a first number;
determining a first handwriting candidate comprising second strokes representing the first character and a third stroke representing a second character, wherein a stroke count of the second strokes is the first number;
determining a second handwriting candidate comprising fourth strokes representing the first character and a fifth stroke representing a third character, wherein a stroke count of the fourth strokes is a second number different from the first number;
displaying the first handwriting candidate and the second handwriting candidate on the screen;
entering the first handwriting candidate into the document, if the first handwriting candidate is selected; and
entering the second handwriting candidate into the document, if the second handwriting candidate is selected.

2. The method of claim 1, wherein the first handwriting candidate is displayed with higher priority than the second handwriting candidate.

3. The method of claim 2, wherein if a plurality of second handwriting candidates exist, a second handwriting candidate comprising fourth strokes representing the first character whose stroke count is a second number greater than the first number is displayed with higher priority than a second handwriting candidate comprising fourth strokes representing the first character whose stroke count is a second number less than the first number.

4. The method of claim 2, wherein if a plurality of second handwriting candidates exist, a second handwriting candidate comprising fourth strokes representing the first character whose stroke count is a second number having a small difference from the first number is displayed with higher priority than a second handwriting candidate comprising fourth strokes representing the first character whose stroke count is a second number having a large difference from the first number.

5. The method of claim 1, wherein a plurality of handwriting candidates including the first handwriting candidate and the second handwriting candidate are displayed according to priority which is assigned according to the first number.

6. An electronic apparatus comprising:
a screen capable of detecting a stroke made on the screen and displaying the stroke;
a memory configured to store a document;
a hardware processor configured to:
display the document on the screen;
receive first strokes representing a first character made on document displayed on the screen, wherein a stroke count of the first strokes is a first number;
determine a first handwriting candidate comprising second strokes representing the first character and a third stroke representing a second character, wherein a stroke count of the second strokes is the first number;
determine a second handwriting candidate comprising fourth strokes representing the first character and a fifth stroke representing a third character, wherein a stroke count of the fourth strokes is a second number different from the first number;
display the first handwriting candidate and the second handwriting candidate on the screen;
enter the first handwriting candidate into the document, if the first handwriting candidate is selected; and
enter the second handwriting candidate into the document, if the second handwriting candidate is selected.

7. The electronic apparatus of claim 6, wherein the hardware processor is configured to display the first handwriting candidate with higher priority than the second handwriting candidate.

8. The electronic apparatus of claim 7, wherein the hardware processor is configured to, if a plurality of second handwriting candidates exist, display a second handwriting candidate comprising fourth strokes representing the first character whose stroke count is a second number greater than the first number with higher priority than a second handwriting candidate comprising fourth strokes representing the first character whose stroke count is a second number less than the first number.

9. The electronic apparatus of claim 7, wherein the hardware processor is configured to, if a plurality of second handwriting candidates exist, display a second handwriting candidate comprising fourth strokes representing the first character whose stroke count is a second number having a small difference from the first number with higher priority than a second handwriting candidate comprising fourth strokes representing the first character whose stroke count is a second number having a large difference from the first number.

10. The electronic apparatus of claim 6, wherein the hardware processor is configured to display a plurality of handwriting candidates including the first handwriting candidate and the second handwriting candidate according to priority which is assigned according to the first number.

11. The electronic apparatus of claim 6, wherein the hardware processor comprises:
means for displaying the document on the screen;
means for receiving first strokes representing a first character made on document displayed on the screen, wherein a stroke count of the first strokes is a first number;
means for determining a first handwriting candidate comprising second strokes representing the first character and a third stroke representing a second character, wherein a stroke count of the second strokes is the first number;
means for determining a second handwriting candidate comprising fourth strokes representing the first character and a fifth stroke representing a third character, wherein a stroke count of the fourth strokes is a second number different from the first number;
means for displaying the first handwriting candidate and the second handwriting candidate on the screen;
means for entering the first handwriting candidate into the document, if the first handwriting candidate is selected; and
means for entering the second handwriting candidate into the document, if the second handwriting candidate is selected.
